(19) United States
(12) Patent Application Publication
(10) Pub. No.: US 2014/0207499 A1
(43) Pub. Date: Jul. 24, 2014

(54) CHECK-IN TO A HOTEL ROOM ONLINE

(71) Applicant: Room 77, Inc., Mountain View, CA (US)

(72) Inventors: Kevin Fliess, Mountain VIew, CA (US); Brad Gerstner, Boston, MA (US); Calvin Yang, Foster City, CA (US); Roger Wong, Mountain VIew, CA (US); Anthony H. Maggio, San Francisco, CA (US); Brian McManus, San Francisco, CA (US); Andrew Patterson, San Francisco, CA (US)

(73) Assignee: Room 77, Inc., Mountain View, CA (US)

(21) Appl. No.: 14/164,034

(22) Filed: Jan. 24, 2014

Related U.S. Application Data
(60) Provisional application No. 61/756,060, filed on Jan. 24, 2013.

(51) Int. Cl. G06Q 50/12; G06Q 10/02

(52) U.S. Cl. CPC G06Q 50/12; G06Q 10/02
USPC 705/5

(57) ABSTRACT

Techniques for allowing prospective hotel guests to check-in online are provided. An online check-in service sends, to a computing device of a prospective guest, an electronic notification that indicates that the prospective user can check-in online instead of having to wait in line at the hotel. A series of pages are presented to the prospective guest, such as a page to allow the prospective guest to specify room preferences and other requests, a page to allow the prospective guest to accept an upgrade offer, a page to confirm payment, and/or a page that shows a room assignment. In this way, a guest does not have to wait in a hotel lobby to be assigned a room. Also, a hotel may be notified when a confirmed guest is approaching the hotel to allow hotel staff to make any arrangements necessary to expedite the process of getting the guest to his/her room.

### CROSS-REFERENCE TO RELATED APPLICATIONS; BENEFIT CLAIM

This application claims the benefit of U.S. Provisional Application No. 61/756,060, filed Jan. 24, 2013, the entire contents of which are hereby incorporated by reference as if fully set forth herein, under 35 U.S.C. §119(e).

### TECHNICAL FIELD

The present disclosure relates to allowing a user to check-in to a hotel through an online process.

### BACKGROUND

The Internet has enabled users to quickly and easily make hotel reservations from anywhere in the world, as long as users have an Internet connection and a suitable browser. Online reservation making has largely replaced lengthy (and potentially expensive) telephone calls or working through a costly travel agency.

However, the process for checking in to a hotel has largely remained unchanged. A guest must arrive at the hotel, wait in line to be served by a hotel employee, provide information to the hotel employee regarding the guest's room preferences and payment, wait until an available room is identified and assigned to that guest, and receive a key or means of unlocking the room.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for allowing a user to check-in to a reservation online, in an embodiment;

FIGS. 2A-2B are flow diagrams that depict a process for checking in a user to a hotel room, in an embodiment;

FIG. 3 is a screenshot of an example email that notifies a prospective guest about checking in to a hotel online, in an embodiment;

FIGS. 4A-4E are screenshots of example pages that are displayed to a user during an online check-in process, in an embodiment;

FIGS. 5A-5E depict screenshots of pages that are displayed successively on a mobile device to allow a user to check-in online, in an embodiment;

FIG. 6 is a screenshot of an example dashboard that includes information about multiple hotels and multiple guests who are confirmed or prospective guests of the hotels, in an embodiment;

FIG. 7 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Individual Habitable Units

An individual habitable unit is a structure that one or more persons may reside in for a period of time. Non-limiting examples of IHUs include hotel rooms, motel rooms, houses, rooms in a house, apartments, condominiums, cottages, cabins, lodges, and bungalows. Thus, an IHU may be purchased or rented by one or more individuals. A set of IHUs may be owned, managed, and maintained as a single entity or establishment (e.g., Hilton™ or Courtyard by Marriot™), which may consist of one or more building structures. Non-limiting examples of such building structures include hotels, motels, apartment complexes, and a condominium complex. A set of IHUs that are maintained or managed by a single business entity or establishment may cover just a few acres of land, although some larger complexes, such as vacation resorts, may consist of IHUs that are spread across a square mile or two. A single business entity or establishment may own or manage different sets of IHUs in different locations, such as one set of IHUs in San Francisco, Calif. and another set of IHUs in Las Vegas, Nev.

An IHU may consist of a single room. However, some IHUs consist of two or more rooms, which might be divided by a wall (or other divider) that includes a door between two rooms of the same IHU.

Also, many IHUs, like many hotel and motel rooms, have one or more walls that adjoin another IHU. IHUs form a “contiguous set” when each IHU in the set shares a wall with at least one other IHU in the set. However, in some cases, IHUs that are part of the same complex do not share walls with any other IHUs in the set. For example, a business entity may own a set of separately-situated bungalows or cottages within a small geographical area, such as a few acres.

Many building structures that include multiple IHUs comprise multiple floors, with multiple IHUs on each floor. In many cases, each floor of such a building structure has the same floor plan. Thus, the set of IHUs on one floor might have the same dimensions and arrangement as another set of IHUs on another floor of the same building.

For purposes of brevity, examples shall be given hereafter in which the IHUs are hotel rooms, and the building complexes to which the IHUs belong are hotels. However, the techniques described herein are not limited to any particular type of IHU or building complex.

### General Overview

Techniques for allowing prospective guests to check-in to a hotel through an online process are provided. A message (e.g., email or text) is sent to a computing device of a user. The message provides details of a reservation that the user has made with a hotel. A series of (e.g., web) pages are presented to the user. For example, one page presents information about upgrading rooms and another page allows the user to specify or change preferences, such as size of room, number of beds in the room, view from the room, proximity to an elevator, a particular floor, etc. The user may even be assigned a particular user during this online check-in process or sometime prior to the guest arriving at the hotel.

### System Overview

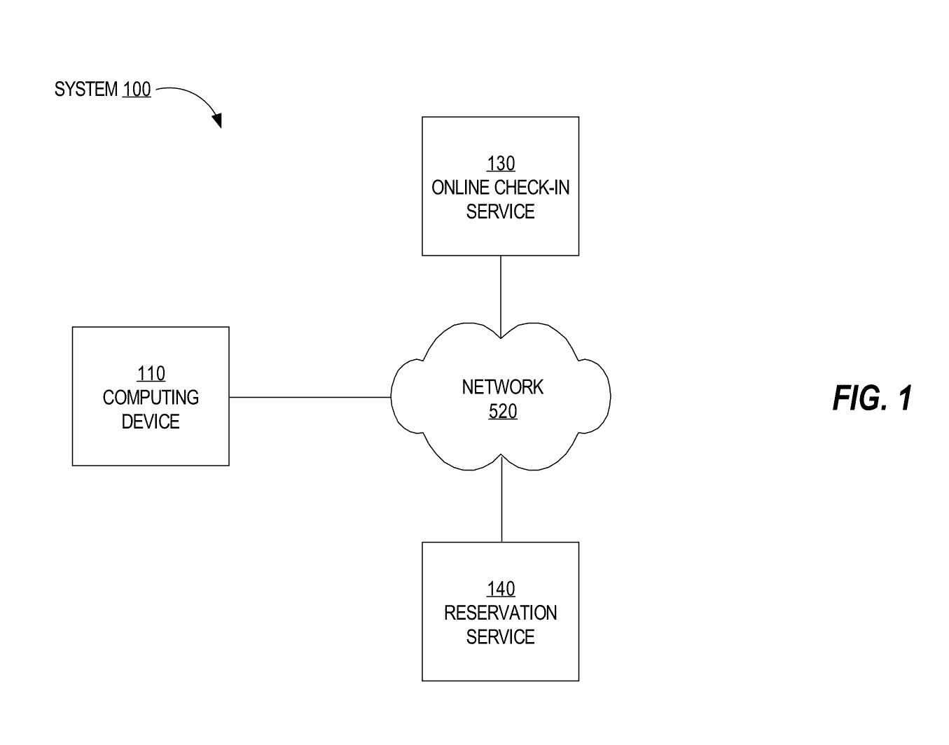

FIG. 1 is a block diagram that depicts an example system 100 for allowing a user to check-in to a reservation online, in an embodiment. System 100 includes computing device 110, network 120, online check-in service 130, reservation service 140, and guest alert computer 150.

Examples of computing device 110 include a desktop computer, a laptop computer, a tablet computer, and a smartphone that is capable of establishing calls over a telephone network and connecting to the Internet. Although only one computing device 110 is depicted for ease of explanation, system 100 may include multiple computing devices.

Communication between computing device 110 and online check-in service 130 and between computing device 110 and reservation service 140 is made possible via network 120. Network 120 may be implemented by any medium or mechanism that provides for the exchange of data between various computing devices. Examples of such a network include, without limitation, a network such as a Local Area Network (LAN), Wide Area Network (WAN), Ethernet or the Internet, or one or more terrestrial, satellite, or wireless links. The network may include a combination of networks such as those described. The network may transmit data according to Transmission Control Protocol (TCP), User Datagram Protocol (UDP), and/or Internet Protocol (IP).

Reservation service 140 is provided by one or more computing devices that are remote relative to computing device 110. Reservation service 140 may be implemented in hardware, software, or any combination of hardware and software. Although only one reservation service 140 is depicted, system 100 may include multiple reservation services that communicate with online check-in service 130. For example, each reservation service may be provided, managed, or owned by a different business entity or property manager. For example, hotel chain A owns one reservation service while hotel chain B (which may be a competitor of hotel chain A) owns another reservation service.

A user of computing device 110 interacts with reservation service 140 through computing device 110 to reserve a hotel room (or other individual habitable unit) at a particular hotel.

In a related embodiment, instead of using computing device 110, the user may use a different device (not depicted) when making a reservation. For example, the user may use a desktop computer to make a reservation at a hotel via reservation service 140 and then use a smartphone to check-in with the hotel.

To reserve a room, computing device 110 (or another device) sends reservation data to reservation service 140, such as a start date and an end date, a type of room or type of bed, and a credit card number. Reservation service 140 determines whether the hotel has one or more available rooms that, for example, satisfy one or more user-specified criteria, such as type or category of room and a date range.

Reservation service 140 transmits reservation data to online check-in service 130. Reservation service 140 may transmit reservation data for a particular reservation upon reserving a hotel room for a prospective guest, may transmit reservation data for a particular reservation upon determining that the corresponding start date is approaching (e.g., two days away), or may transmit reservation data for multiple reservations, for example, at the end of each business day.

Reservation service 140 may also transmit specific hotel room information that indicates which rooms are available for one or more prospective guests and attributes of such rooms. With specific hotel room information, online check-in service 130 may present current information to a prospective guest to allow the guest to upgrade his/her reservation and/or know which room s/he will be staying in before the guest arrives at the hotel.

Online check-in service 130 is provided by one or more computing devices that are remote relative to computing device 110. Online check-in service 130 may be implemented in hardware, software, or any combination of hardware and software.

Online check-in service 130 may be provided by the same or different entity that owns or manages reservation service 140. For example, online check-in service 130 and reservation system 140 may execute on the same system of one or more computing devices. As another example, online check-in service 130 may be provided by one business entity and interact with multiple reservation systems provided by other business entities.

### Online Check-In Process

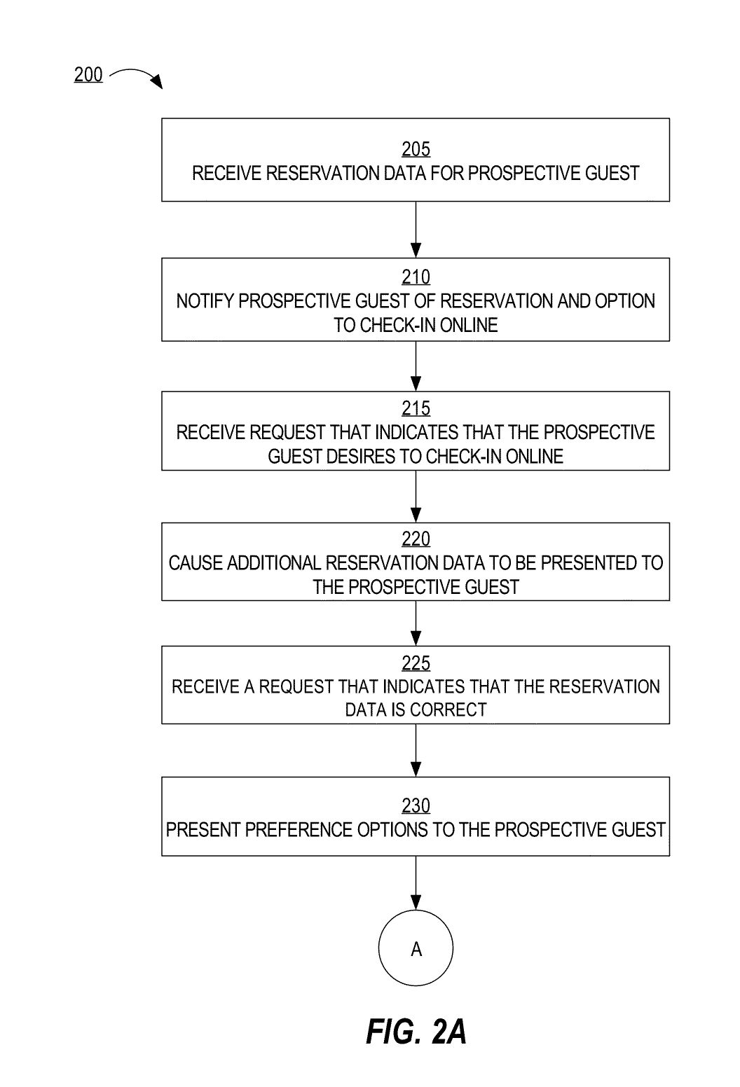

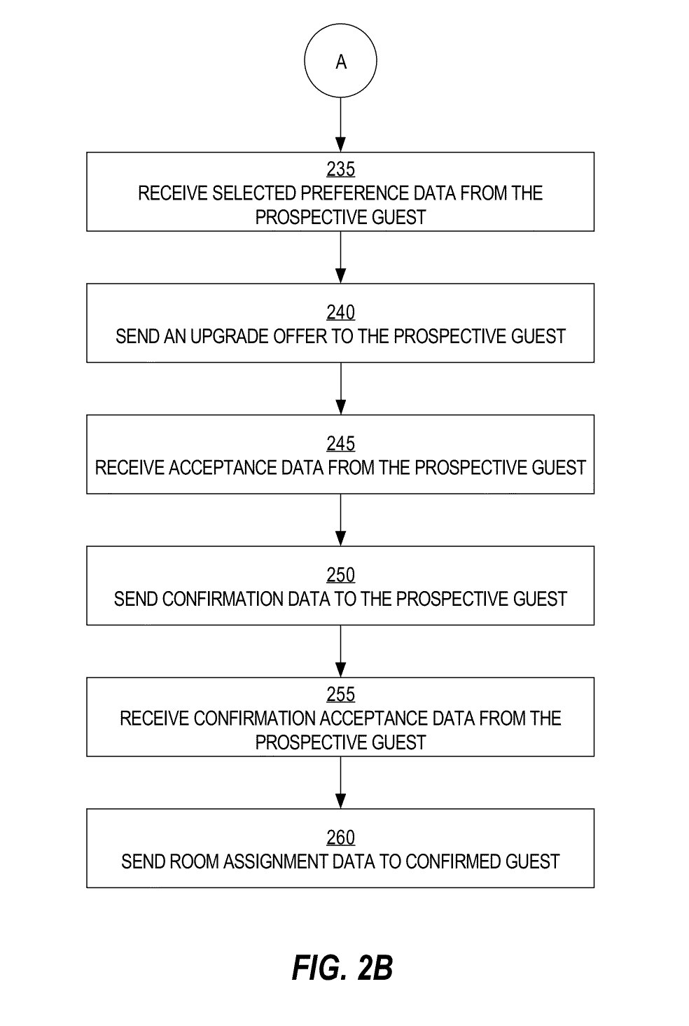

FIGS. 2A-2B are flow diagrams that depict a process 200 for checking in a user to a hotel room, in an embodiment. Process 200 may be performed by online check-in service 130.

At block 205, reservation data for a prospective guest is received. Reservation data may include a start date, an end date, a room category or type (e.g., “Presidential Suite”), and/or a price per night or estimated price range.

A “prospective” guest is a person who has made a reservation with a hotel but has not yet checked in to the hotel. A prospective guest becomes a “confirmed” guest after the prospective guest has checked in to the hotel through an online process.

The prospective guest may have established the reservation with reservation service 140 using computing device 110 (or another device, not depicted in FIG. 1).

Upon establishing a reservation, a unique reservation number may be assigned to or associated with the prospective guest. The reservation number can be used by the prospective guest (or others) to retrieve information about the guest's reservation.

Block 205 may involve reservation service 140 sending the reservation data to online check-in service 130. As noted above, reservation service 140 may send the reservation data to online check-in service 130 immediately upon creation of the reservation or later, such as in a batch of reservations of multiple prospective guests.

### Reservation Notification

At block 210, the prospective guest is notified of his/her reservation. The prospective guest may be notified by email, text message, or other message to a client (e.g., mobile) application executing on computing device 110. The client application may be an application that is provided by the same entity that owns or manages online check-in service 130. An example notification may be an icon that is displayed on or adjacent to an app icon that represents a mobile application and that is displayed among other app icons representing other mobile apps. The notification may also involve an audible sound or a vibration of computing device 110. Selection of the app icon may cause the mobile application to open and display a message.

The notification may be sent to the prospective guest based on one or more criteria being satisfied. For example, two days prior to the start date of an expected stay by a prospective guest, online check-in service 130 (or reservation service 140) sends the notification to the prospective guest (e.g., via email or text message). In this example, the trigger for sending the notification is a time-based trigger. Another example trigger may be the number of available rooms, number of possible upgrades, or number of guests who have already checked-in and whose stays overlap the expected stay of the prospective client.

The notification message, whether provided in an email message, a text message, or an app message, may include details about the reservation that the prospective guest made, such as the name of the hotel, the length of stay, a reservation number, and/or a price per night.

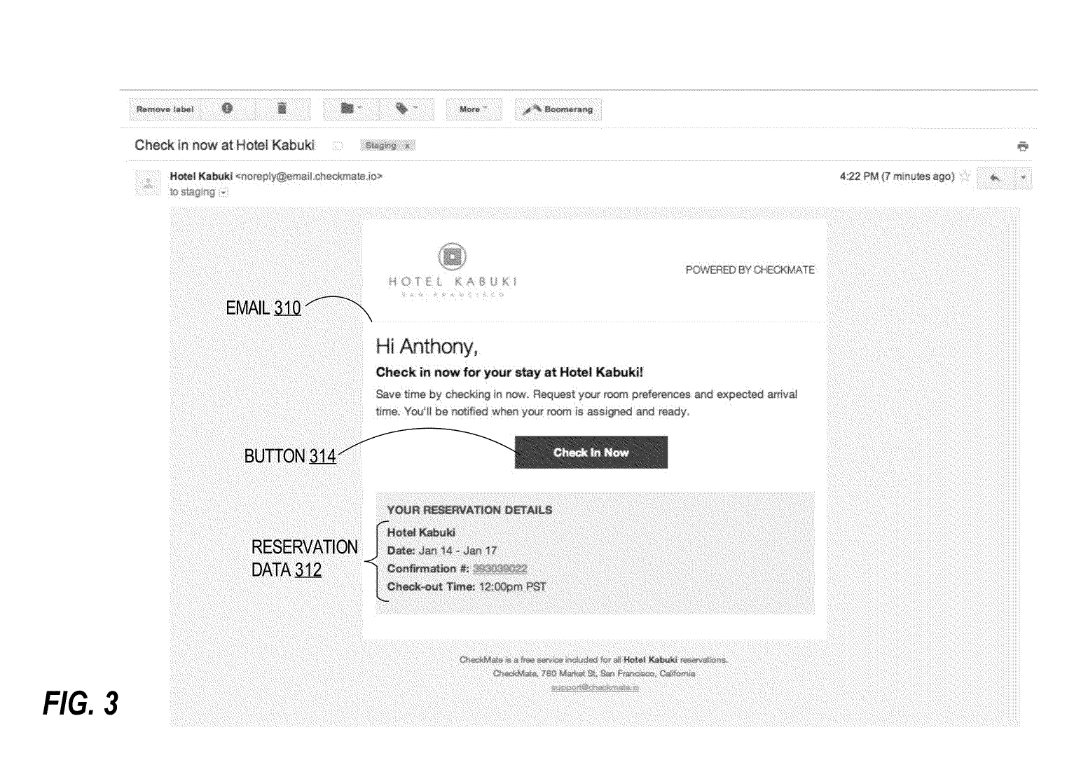

FIG. 3 is a screenshot of an example email 310 that is sent to an email account of the prospective guest, in an embodiment. Email 310 includes reservation data 312, which includes the name of the hotel (i.e., “Hotel Kabuki”), a date range for the reservation (i.e., “January 14-January 17”) a confirmation number that is associated with the reservation, and a check-out time (i.e., “12:00 pm PST”).

Returning to FIG. 2, at block 215, a request is received that indicates that the prospective guest desires to check-in online. Block 215 may involve the prospective guest selecting a check-in button 314 included in email 310. Selecting button 314 may cause a HTTP request that includes a URL to be sent to online check-in service 130. The URL may contain information that uniquely identifies the prospective guest or the reservation (since a single user may have multiple reservations) so that online check-in service 130 can determine which page to provide to computing device 110 in response to the HTTP request.

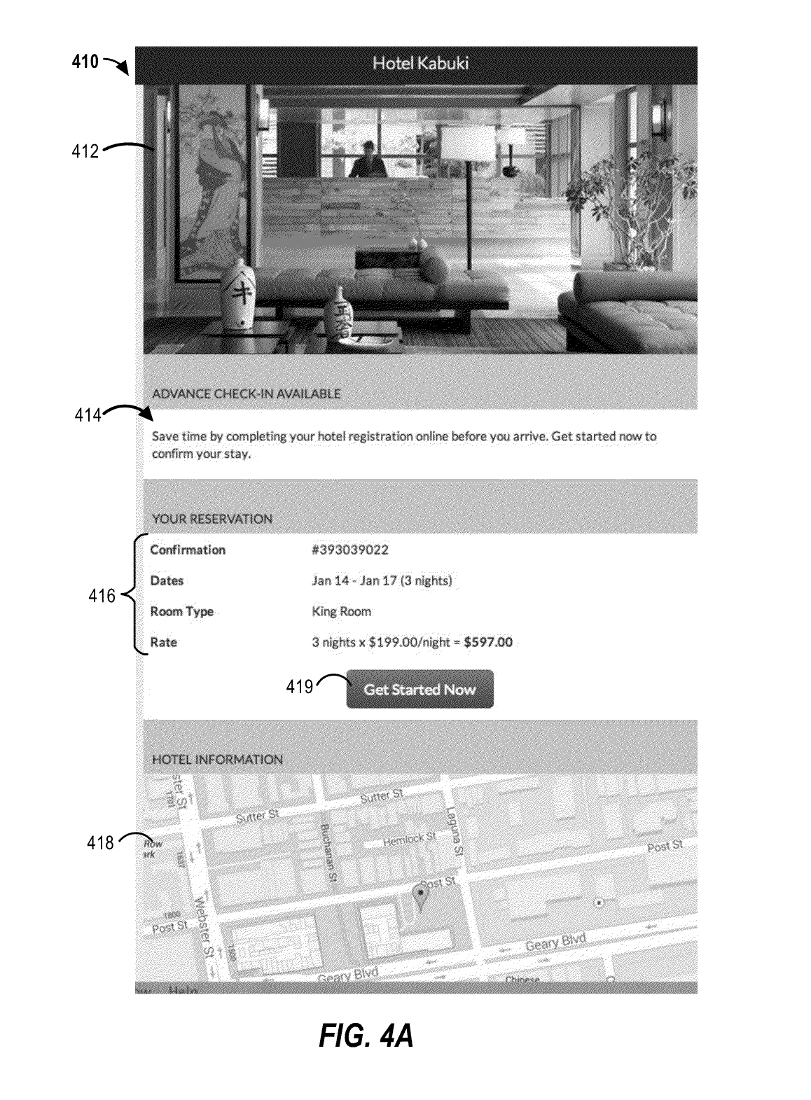

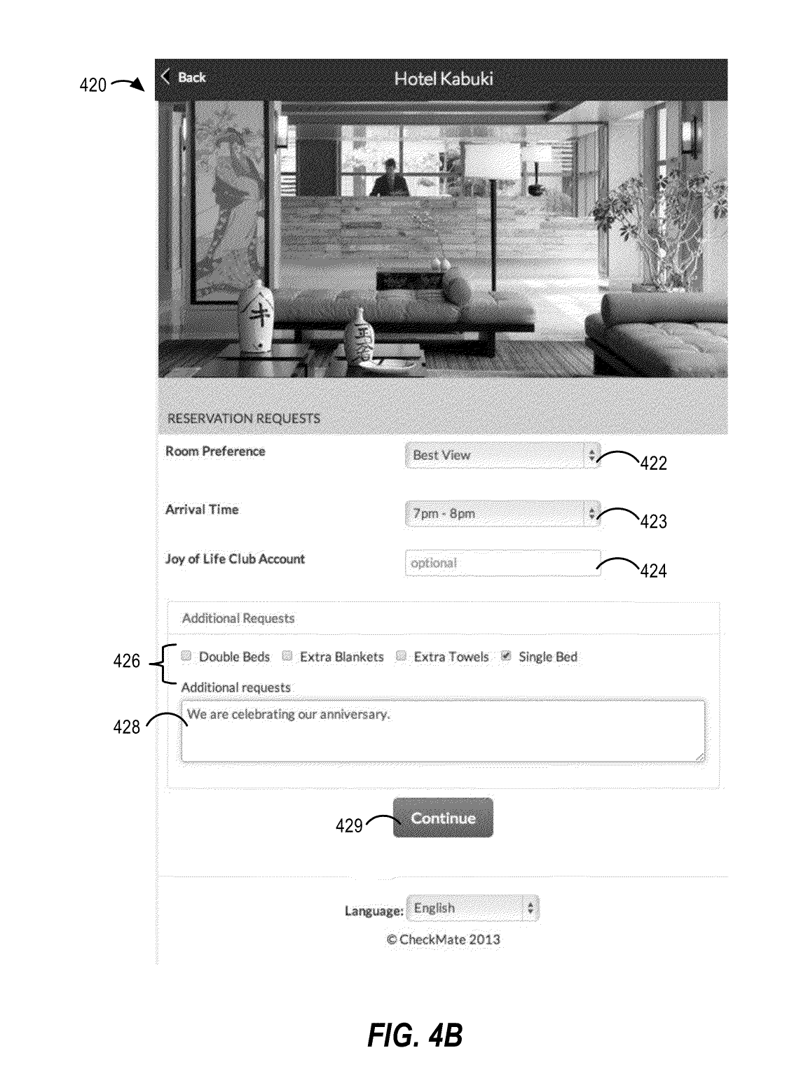

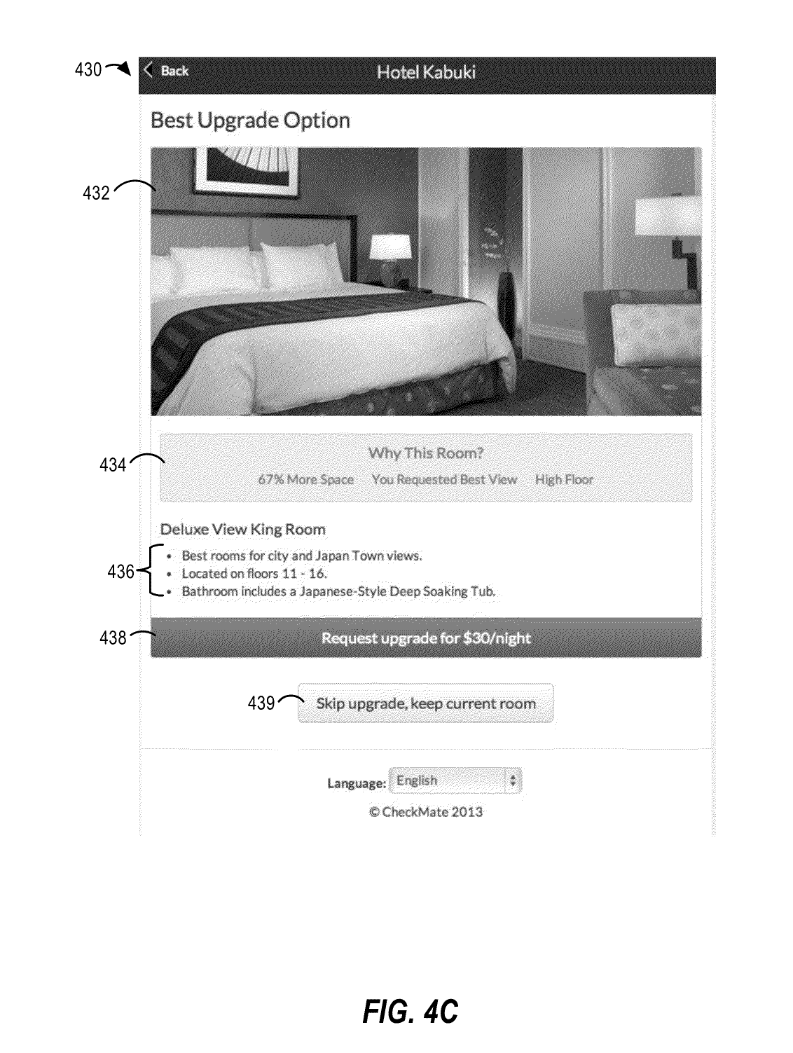

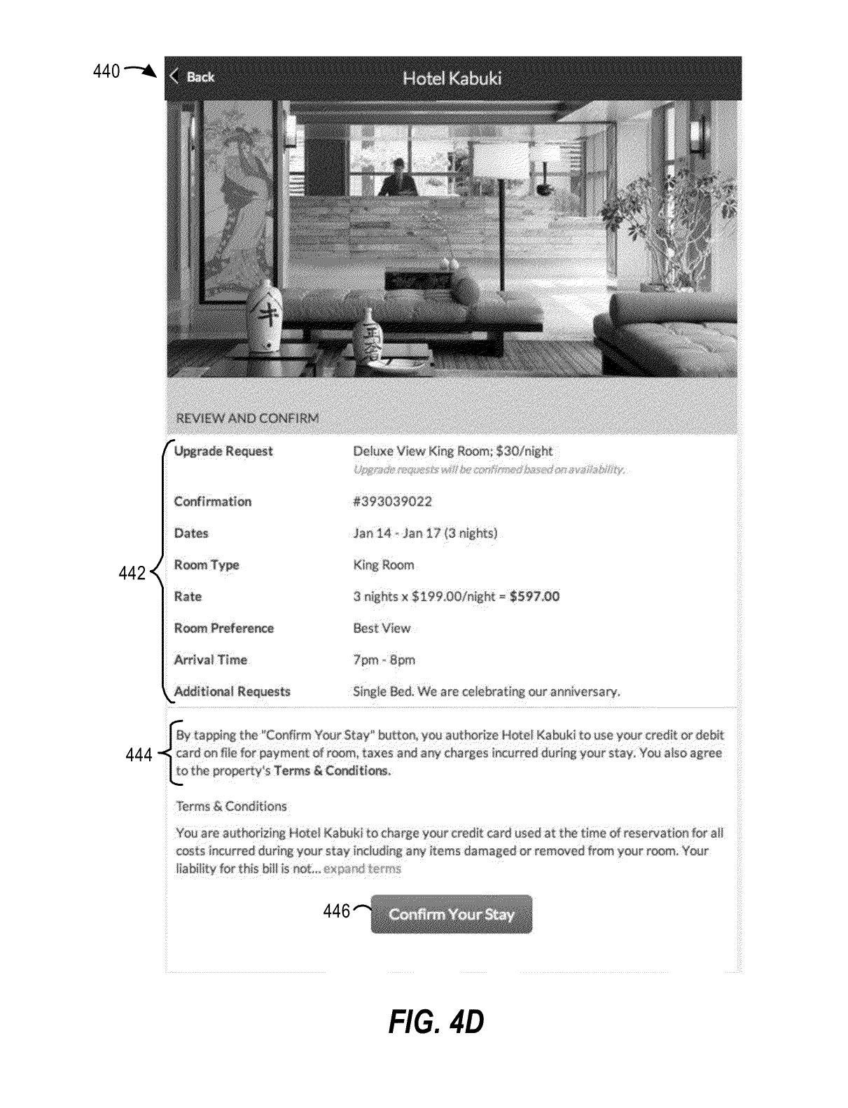

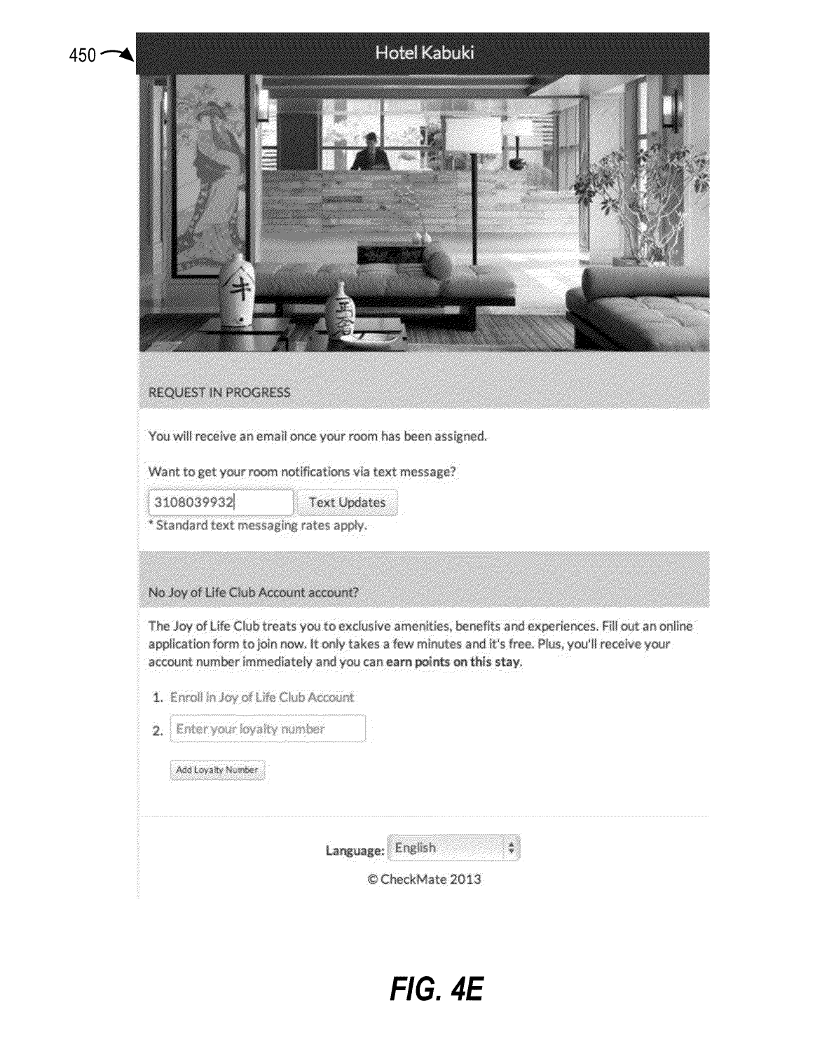

At block 220, reservation data is presented to the prospective guest. For example, in response to receiving, from computing device 110, data that indicates user selection of check-in button 314, online check-in service 130 causes a page 410 depicted in FIG. 4A to be displayed on a display screen of computing device 110.

Page 410 (along with pages 420-450 described below) may be displayed within a web browser or within a dedicated client application executing on computing device 110. Page 410 includes a digital image 412 of the lobby of the hotel, a message 414 informing the prospective guest that s/he can complete registration by checking in online, reservation details 416 (such as dates of reservation, room type, and room rate), and a map 418 of a geographical area that includes the hotel.

In an embodiment, after each button that causes a new page to be displayed, online check-in service 130 maintains state information that indicates which information has been provided thus far to the prospective guest regarding the particular reservation. In this way, if the prospective user starts over, online check-in service 130 may determine which content to provide to the prospective guest (e.g., via computing device 110), so that the prospective guest does not have to traverse through pages and content that the prospective guest has already viewed.

At block 225, a request is received that indicates that the reservation data is correct. For example, page 410 includes a button 419 that, when selected, causes computing device 110 to send a request to online check-in service 130.

### Preference Selection

At block 230, preference options are presented to the prospective user. For example, in response to user selection of button 419, online check-in service 130 generates and causes a page 420 (depicted in FIG. 4B) to be displayed on a display screen of computing device 110.

In an alternative embodiment, process 200 proceeds from block 215 directly to block 230. In this embodiment, page 410 is not displayed. Instead, any details that are displayed in page 410 may have been displayed in email 310.

Page 420 includes a room preference selector 422, an arrival time selector 423, a membership account field 424, additional request options 426, and an additional request input field 428. Room preference selector 422 and arrival time selector 423 are drop down menus that allow a user to select, respectively, a room preference from among multiple possible room preferences and an arrival time from among multiple possible arrival times. Other techniques may be used to allow a user to select a room preference and/or an estimated arrival time.

Examples of room preferences include Best View, Lowest Noise Level, Furthest Distance from Elevator, Closest to Stairs, Closest to Lobby, No Smoking, Smoking Allowed, Patio Included, Closest to Vending Machine, Top Floor, and Ground Level. In a related embodiment, a prospective guest may select multiple room preferences that are non-exclusive, such as Top Floor and Furthest Distance from Elevator.

While arrival time selector 423 shows increments of a single hour, other increments may be used such as two hours or 30 minutes.

Additional request options 426 include options for requesting double beds, extra blankets, extra towels, and a single bed. Additional request options 426 may include less or more options, such as a crib, extra sheets, an extra mattress, and hypoallergenic sheets.

Additional request input field 428 allows a user to input text (or audio or video) providing additional information to alert hotel staff, such as specific requests that are not available in additional request options 426 or non-requests, such as notifying the hotel staff that the guest is visiting the hotel as part of a wedding anniversary or a birthday party is planned.

In an embodiment, online check-in service 130 stores user preference data on an individual user basis. For example, online check-in service 130 stores (1) preference data for guest A that indicates that guest A has selected Best View as a room preference previously and (2) preference data for guest B that guest B has selected an arrival time of 7 pm for the guest's last three reservations. Thus, when page 420 is provided to guest A, the room preference of “Best View” may be displayed as a default selection and when a different instance of page 420 is provided to guest B, an estimated arrival time of “7 pm-8 pm” may be displayed as a default selection.

Additionally or alternatively, page 420 may be different based on with which hotel a prospective guest has made a reservation. For example, some hotels may not have multi-level structure; therefore, a Top Floor preference may not be presented to the prospective guest. Online check-in service 130 may store hotel specific preference data and determine, based on the request from a prospective user's computing device, which hotel is associated with the request and then identify preference data that is associated with the determined hotel. The preference data is then included in page 420.

A single guest may be different preferences for different hotels or hotel chains. For example, guest A may have selected “Best View” as a room preference for hotel chain T and may have selected “Ground Level” as a room preference for hotel chain U. Thus, in an embodiment, online check-in service 130 stores preference data for a particular user on a hotel and/or hotel chain basis. If guest A has decided to proceed with online check-in for a hotel from hotel chain T, then online check-in service 130 identifies the hotel, the user, and determines based on both that the “Best View” preference will be a default selection in page 420.

At block 235, selected preference data is received from the prospective guest. For example, page 420 includes a continue button 429 that, when selected, causes computing device 110 to send, to online check-in service 130, preference data that indicates user (and/or default) selections of one or more preferences.

### Upgrade Option

At block 240, an upgrade option is sent to the prospective guest. For example, in response to receiving the selected preference data, online check-in service 130 generates and causes page 430 (depicted in FIG. 4C, or page 440 depicted in FIG. 4D) to be displayed on the display screen of computing device 110.

Page 430 includes upgrade data that indicates an offer to upgrade from the prospective guest's previously selected room type to another room type before checking in online. Additionally or alternatively, the upgrade data may indicate another attribute of the room or of the hotel that the prospective guest may receive, such as use of an indoor gym or swimming pool and in-room food service.

In an embodiment, online check-in service 130 stores upgrade data on a per hotel basis. Based on the current room type that the user selected during the reservation process (e.g., with reservation service 140), online check-in service 130 determines which upgrade option to present to the prospective guest. If online check-in service 130 supports multiple hotels, then the determination may also be based on which hotel that is part of the reservation, since different hotels (especially from different hotel chains) typically have different room types and amenities.

In the example of FIG. 4C, page 430 includes an image 432 of a room (or room type) to which the prospective guest may be upgraded, distinction data 434 that includes features that the upgraded room has that are not shared by a room (or room type) that the user has already reserved (e.g., “67% More Space”), attribute data 436 that indicates other features of the upgraded room (e.g., the type of tub, where rooms of the upgraded room type are found), and price data 438 that indicates how much extra the upgrade would cost (e.g., on a per night basis or a per stay basis). In this example, price data 438 is displayed on a button that, when selected, causes upgrade information to be stored in association with the present reservation. The upgrade information may be used to determine how much to charge the prospective guest and notify the hotel about what room type the user has finally reserved.

At block 245, acceptance data is received from the prospective guest. The acceptance data indicates whether the prospective guest accepted or declined the upgrade offer presented in page 430. For example, page 430 includes a button 439 that, when selected, causes computing device 110 to send, to online check-in service 130, decline data that indicates that the prospective guest not accept the upgrade offer. As another example, selection of the upgrade button in page 430 causes acceptance data to be sent to online check-in service 130.

### Confirmation

At block 250, confirmation data is sent to the prospective guest. For example, in response to receiving acceptance data from computing device 110, online check-in service 130 generates and causes page 440 (depicted in FIG. 4D) to be displayed on the display screen of computing device 110.

Page 440 contains information 442 about the prospective guest's reservation and allows the prospective guest to confirm the reservation and complete check-in. Such information includes a confirmation number (of the original reservation, for example, through reservation service 140), a date range of the expected stay, a room type, a rate, one or more room preferences, expected arrival time, and any additional requests made by the prospective guest. In this example, page 440 indicates that the prospective guest accepted the upgrade offer described in page 330.

Page 440 also includes text 444 that indicates selection of a confirm button 446 authorizes the hotel to use a credit card, debit card, or other financial account associated with the prospective guest for payment of a room, taxes, and any charges incurred during the planned stay. Selection of confirm button 446 causes page 450 depicted in FIG. 4E to be displayed. After selection of confirm button 446, the prospective guest becomes a confirmed guest.

At block 255, confirmation acceptance data is received from the prospective guest. The confirmation data indicates that the prospective guest confirmed the reservation and has authorized the hotel to charge the guest's credit or debit card for payment. For example, the prospective guest selects confirm button 446, which causes computing device 110 to send the confirmation data to online check-in service 130.

Instead of selecting confirm button 446, the prospective guest may instead select a back button or another button or link to, for example, “undo” an upgrade, accept a previously-declined upgrade offer, change the length of stay or room type, change previously-selected preference(s), or cancel the reservation altogether. In this embodiment, block 255 would not be entered, at least after the first iteration of block 250. Instead, block 255 may never be entered for the prospective guest with respect to the present reservation or may be entered later after entering one or more previously-entered blocks a second time.

### Room Assignment

At block 260, room assignment data is sent to the now-confirmed guest. For example, in response to receiving the confirmation data, online check-in service 130 generates and causes page 450 (depicted in FIG. 4E) to be sent to computer device 110 for display.

Page 450 includes information about a room assignment for the confirmed guest. Specifically, the confirmed guest may be allowed to specify how the confirmed guest will be notified of a room assignment. In the example of page 450, the confirmed guest is notified that s/he will receive an email message that identifies the room. Page 450 allows the confirmed guest to receive a room notification through text message. To do so, the confirmed guest may enter a cell phone number. A room assignment message may be sent from online check-in service 130 or online check-in service 130 may provide an email address or phone number of the confirmed guest to the hotel, which may be responsible for sending the room assignment message to the confirmed guest.

Page 450 (or another page) may also include a scannable code (not depicted), such as a QR code or a bar code, that uniquely identifies the confirmed reservation. For example, the scannable code may encode the reservation number. The scannable code may be presented to hotel staff when the confirmed guest arrives at the hotel. Based on the scannable code, a hotel computer may determine to which room the confirmed guest is assigned.

### User-Selected Room

In an alternative embodiment, a prospective guest (or a confirmed guest) is allowed to select a specific room from a hotel. For example, online check-in service 130 provides a room selection page (e.g., page 420 or another page) that displays a floor plan of a particular floor of the hotel. The floor plan indicates multiple hotel rooms. Some of the hotel rooms may be visually distinguished (e.g., highlighted) from other hotel rooms in the floor plan. Such distinguishing may be based on which hotel rooms are available and, optionally, satisfy currently-selected (whether default or user-selected) room preference options. If the hotel has multiple floors, then the room selection page may also include a floor selector that allows the user to select another floor from among a plurality of floors and, as a result of the selection, view information about multiple hotel rooms on the selected floor.

In order to display information about specific rooms, online check-in service 130 has access to the inventory of the hotel. Thus, online check-in service 130 may access a property management database of the hotel, which database includes which hotel rooms are available on each data and one or more attributes of each hotel room.

Examples of how room-specific information may be derived are provided in U.S. patent application Ser. Nos. 13/208,147 and 13/208,153, the entire contents of each of which are incorporated herein by reference.

A floor plan of a hotel may indicate, for one or more hotel rooms, an icon (e.g., a dollar sign ‘$’) that indicates an upgrade opportunity that the user may select. The floor plan may also indicate other features of the hotel, such as the location of the stairs, elevator, and vending machine(s) on the corresponding floor.

If a user selects a particular room, then a room specific page may be displayed that provides details about the selected room, such as room number, number of beds, size of the bed(s), size of the room, whether smoking is allowed, whether pets are allowed, whether a patio is included, other amenities, and one or more images. The one or more images may be of the room itself and/or of a view from a window of the room. The images may be actual photos taken by another user or may be a computer-rendered view that is based on the geographical coordinates of the room. If multiple images are associated with the selected room, then the room specific page may include a scroll mechanism that allows the user to scroll through multiple images (or “photo reel”).

### A Second Example of Online Check-In

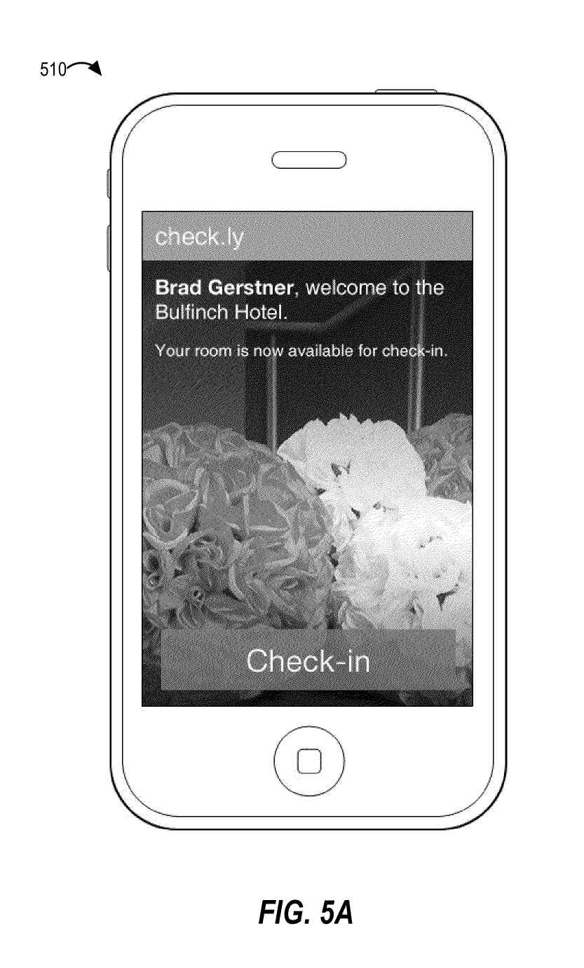

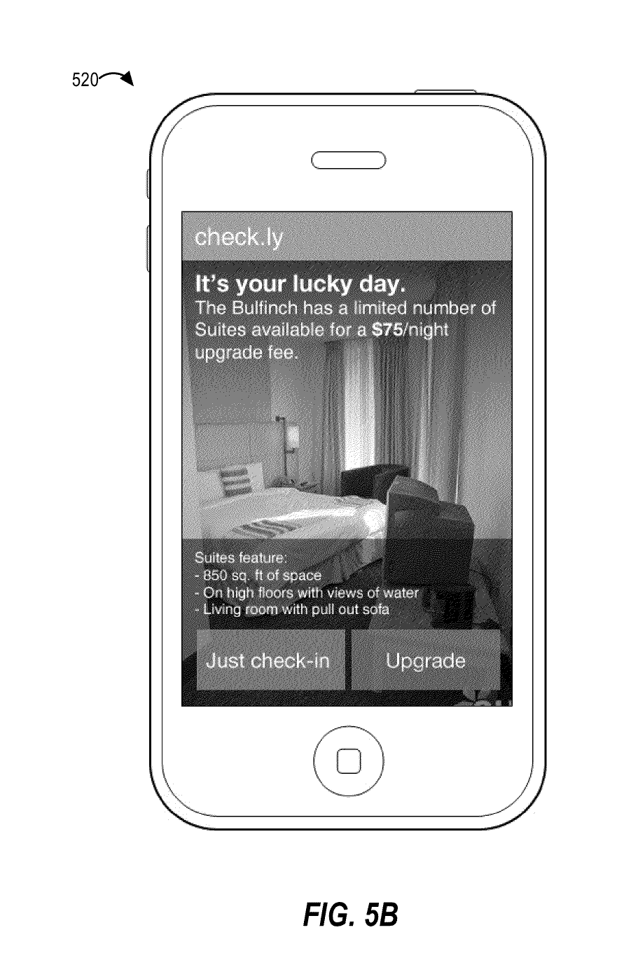

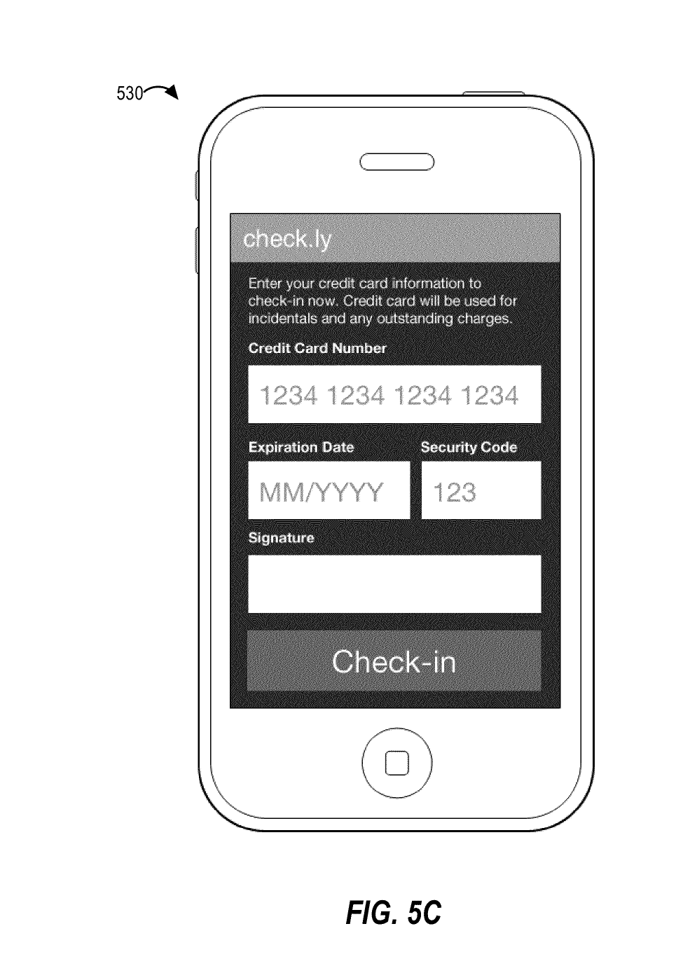

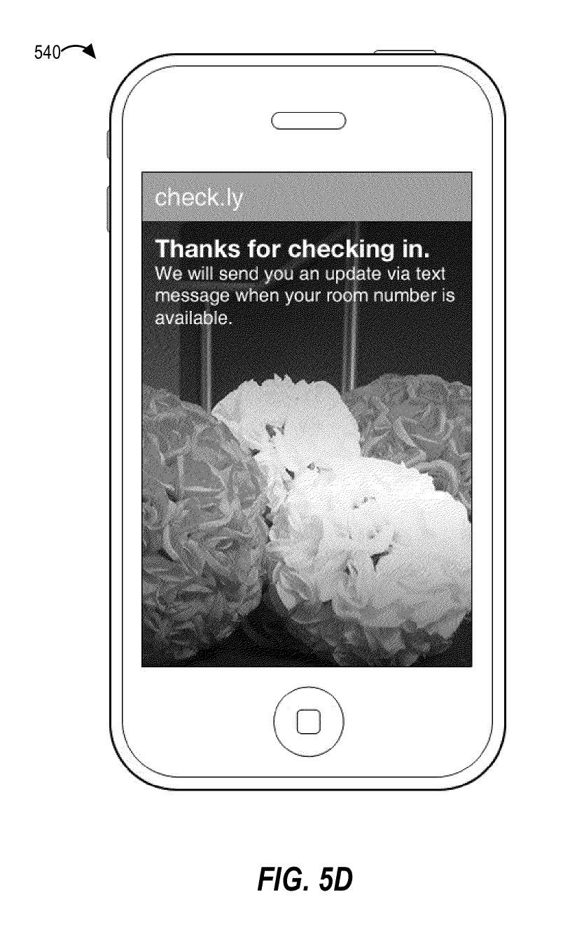

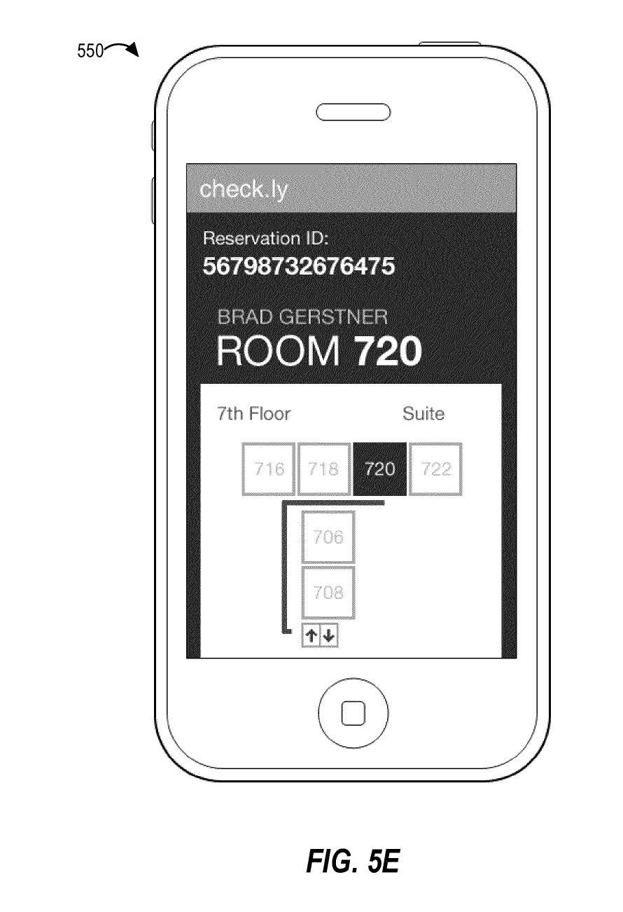

FIGS. 5A-5E depict screenshots of pages 510-550, respectively, that are displayed on a mobile device to allow a user to check-in online, in an embodiment.

Page 510 includes an invitation to a user of the mobile device to check-in using the mobile device. In response to selecting the “Check-in” button, page 520 is displayed.

Page 520 includes information about a possible upgrade to the user's original reservation. The information indicates a size of the upgraded room, the possible views, the relative height of floors on which upgraded rooms are located, and a price per night fee for selecting the upgrade. Page 520 includes a button to proceed with check-in without the upgrade and a button to proceed with check-in with the upgrade. In response to selecting one of the two buttons, page 530 is displayed.

Page 530 includes fields for allowing the user to enter credit card information, such as number, expiration date, and security code. If the user has used this online check-in process previously and used a credit card then, even with another hotel, the credit card information may already be filled in when page 530 is displayed. Alternatively, instead of showing the credit card information, page 530 may have been skipped and page 540 is displayed upon selection of one of the buttons on page 520.

Page 540 includes information that confirms that the user has been checked-in and that indicates that the user will be notified when a room is assigned to the user.

Page 550 is later displayed on the mobile device and indicates a reservation identifier, the name of the confirmed guest, a room number (i.e., 720 in this example) assigned to the confirmed guest, a portion of a map of the 7^{th} floor on which the room is located, and a suggested path for the user to follow from elevators on the 7^{th} floor to the assigned room.

### Notifying a Hotel of a Guest's Arrival

In an embodiment, a hotel computer receives a notification that a confirmed guest is about to arrive at the hotel based on location data associated with the confirmed guest. For example, a mobile application on computing device 110 that a user is carrying transmits, to online check-in service 130, geographical data about the user's location. Such a transmission may occur repeatedly, such as every five minutes. The geographical data may include latitude and longitude coordinates of computing device 110 or of a network device that is in communication with computing device 110, such as a cell tower or a Wi-Fi access point.

The geographical data may be transmitted to online check-in service 130 (or another service not depicted). Online check-in service 130 compares the geographical location of computing device 110 with the geographical location of the hotel with which the user of computing device 110 has checked in online. Online check-in service 130 determines a distance between computing device 110 and the hotel. Online check-in service 130 may compare this distance with a “geo-fence” associated with the hotel. A geo-fence is an imaginary boundary that surrounds a location (such as a hotel) and, if crossed by certain people or things, triggers an action, such as an alert. For example, a geo-fence may be a circle that is ten miles from a hotel in each direction.

While this example is a distance-based geo-fence, a geo-fence may be time-based. For example, online check-in service 130 may estimate how long it will take for the confirmed guest to arrive at the hotel based on the calculated distance. If online check-in service 130 estimates that a confirmed guest will arrive at the hotel in fifteen minutes and the hotel is associated with a 15-minute geo-fence, then online check-in service 130 will send an alert.

Online check-in service 130 send an alert to one or more computers of the hotel, which computer(s) may interact with online check-in service 130 through a web browser or a client application developed by online check-in service 130 or by a business entity that owns or manages the hotel. A hotel computer may be a desktop computer or a handheld device, such as a tablet computer, a laptop computer, or a smartphone.

Different hotels may be associated with different “sized” geo-fences. For example, the geo-fence for one hotel may be ten miles while a geo-fence for another hotel may be four miles or twenty minutes.

In an embodiment, a single hotel may be associated with multiple geo-fences. Thus, as a confirmed guest (or the guest's computing device) “crosses” each geo-fence, online check-in service 130 sends a different alert to one or more computers of the hotel. For example, online check-in service 130 sends a first alert when computing device 110 is within ten miles of the hotel and sends a second alert when computing device 110 is within two miles of the hotel.

Using the arrival alerts, hotel staff can make preparations, before the confirmed guest arrives, in order to best serve the confirmed guest. For example, a room key may be printed in advance and ready for the confirmed guest to pick up upon his/her arrival. The confirmed guest may skip any line of other guests who have not checked in online and who are waiting for a room assignment.

### Hotel Portal

As described previously, online check-in service 130 may be operated by a different entity than the entity (or entities) that operate the hotel(s) with which prospective guests have made reservations. In this way, the property manager(s) of the hotel(s) are not required to build their own online check-in process. Furthermore, the operator of online check-in service 130 may leverage any room-specific information (e.g., floor plans, room size, etc.) that the operator has generated previously (or has access to) to provide intelligent upgrade offers.

In an embodiment, the pages provided to a user as part of the online check-in process may be branded with the specific hotel's brand information, such as logo and pictures of the hotel's property. Pages 410-450 are examples of pages that include the brand of the hotel to which the prospective guest is checking in. In this way, the prospective guest has the impression that the check-in process is provided by the hotel or hotel chain with which the prospective guest has made a reservation.

In an embodiment, online check-in service 130 provides a hotel portal that allows representatives of different hotels, hotel chains, and/or travel agencies to register with online check-in service 130. A hotel representative sends, for example, one or more images (e.g., image 412 in page 410), descriptions and/or images of each room or room type, room assignment policies, and/or payment requirements. For example, one hotel may accept a particular credit card while another hotel does not. As another example, one hotel may want to assign a room to the prospective guest immediately while another hotel may want to wait until the day before or the day of a stay to assign a room. As another example, one hotel may want to have each prospective guest receive an upgrade offer while another hotel may want to have only certain prospective guests receive an upgrade offer. For example, if a prospective guest has declined 3 upgrade offers in a row for other reservations (whether from that hotel or other hotels), then the hotel may not want extend upgrade offers to that prospective guest. Each of these requirements and other hotel-specific information are used by online check-in service 130 to provide an appropriate and branded experience for prospective guests of different hotels.

In an embodiment, a hotel or hotel chain provides, to online check-in service 130, access to room information of the hotel or hotel chain. For example, the room information may be room category information for multiple hotels of a particular hotel chain. Online check-in service 130 uses the room category information to determine upgrade offers for prospective guests of the hotels. As another example, the room information may include vacancy data that indicates which rooms (or simply which room categories have one or more rooms that) are available on which days. This information may be used by online-check-in service 130 to provide an upgrade offer to a prospective guest, assign a room immediately to a confirmed guest, or allow a confirmed guest to select a room at the end of the online check-in process.

Access to room information may be in the form of a web service that a hotel or hotel chain maintains. Authorization data, such as a username and password, may be required to allow online check-in service 130 to send requests to, and receive responses from, the web service in order to access the hotel's room information. For example, a request may include a date range on which a prospective guest has reserved a stay at a hotel. The web service may maintain up-to-date vacancy (or availability) information on each room of the hotel as well as a description of each room's type or category and a cost of each room or room category.

In an embodiment, online check-in service 130 is compensated from hotels, hotel chains, or travel agencies based on guests who have accepted upgrade offers. For example, online check-in service 130 may receive 25% of the value of an upgrade from hotel A if a prospective guest of hotel A accepts an upgrade offer. For example, if an upgrade offer of $100 extra per night is accepted by a prospective guest, then hotel A (or an affiliate, such as a parent company) will pay $25 to online check-in service 130.

### Dashboard

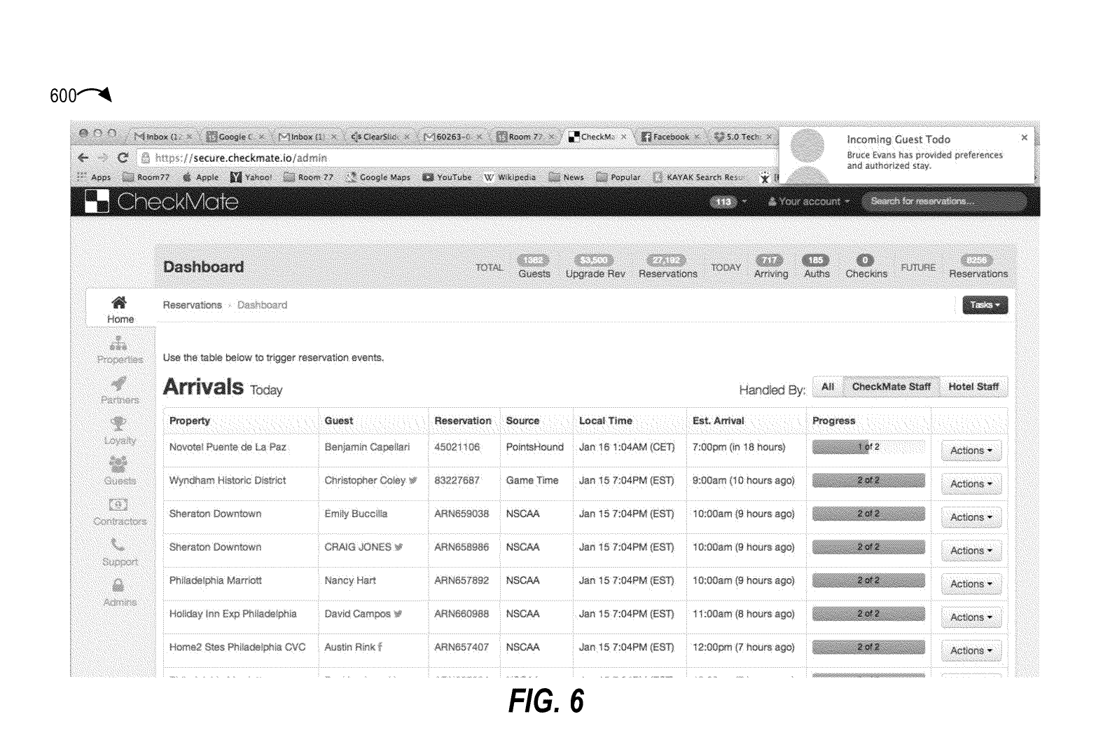

FIG. 6 is a screenshot of an example dashboard 600 that includes information about multiple guests who are confirmed or prospective guests, in an embodiment. Dashboard 600 may be created and maintained by online check-in service 130.

Dashboard 600 lists guests who have planned stays that begin on the current day. For each guest, dashboard 600 indicates the name of the hotel, a reservation number (which may be unique relative to the other reservations of the same hotel or property), the current local time, an estimated arrival of the guest, and progress of the guest. In this example, two actions are tracked: online check-in and physical check-in. According to dashboard 600, all but one guest have done both. The first listed guest has checked-in online but has not yet arrived at the appropriate hotel; at least there is no record of the guest having arrived at the hotel.

If dashboard 600 is provided by or to a specific hotel, then the column for hotel or property name may be removed.

In the depicted example, dashboard 600 includes options to view:
a number of guests who have check-in online;
a number of guests who have upgraded;
a revenue amount of all upgrades (on a hotel basis, a hotel chain basis, and/or a total basis);
a total number of reservations for stays that have already passed or begun;
a number of guests who have scheduled stays beginning today;
a number of guests who have authorized their credit card or debit card for payment;
a number of future reservations for stays that have not yet begun;
an identity of a guest who is checking in, including one or more images of the guest, demographic information, links to online profiles of the guest, and reviews of other hotels written by the guest;
a time at which guests are scheduled to arrive or a distance of the guests from their respective destinations.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

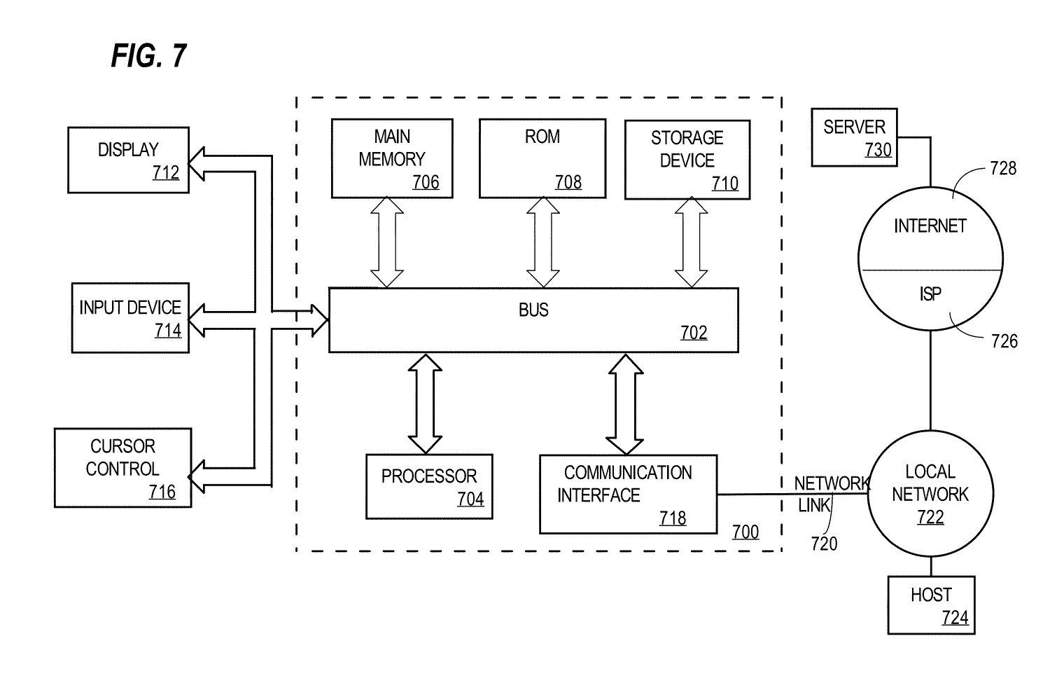

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving, from a first entity associated with a first hotel, first reservation data about one or more first guests that have made reservations with the first hotel;
determining, based on one or more criteria and the first reservation data, to notify a first guest, of the one or more first guests, of a check-in opportunity to the first hotel;
causing, to be displayed on a first display screen of a first computing device of the first guest, first individual reservation data that includes first information about a first reservation that is reflected in the reservation data;
receiving, from the first computing device of the first guest, first input that indicates that the first user confirms the first reservation;
wherein the method is performed by one or more computing devices.

2. The method of claim 1, further comprising:
receiving, from a second entity associated with a second hotel that is different than the first hotel, second reservation data about one or more second guests that have made reservations with the second hotel;
determining, based on one or more second criteria and the second reservation data, to notify a second guest, of the one or more second guests, of a second check-in opportunity to the second hotel;
causing, to be displayed on a second display screen of a second computing device of the second guest, second individual reservation data that includes second information about the second reservation;
receiving, from the second computing device of the second guest, second input that indicates that the second user confirms the second reservation.

3. The method of claim 1, further comprising:
causing, to be displayed on the first computing device of the first guest, update data that indicates information about an upgrade offer and a cost of the upgrade offer if the first guest selects the upgrade offer,
wherein the information about the possible upgrade includes one or more attributes of a second type of room that is different than a first type of room that the first guest initially reserved, wherein the one or more attributes of the second type of room distinguish the second type of room from the first type of room.

4. The method of claim 3, further comprising:
after causing the update data to be displayed, receiving, from the first computing device of the first guest, second input that indicates that the first guest selected the upgrade offer.

5. The method of claim 1, further comprising:
receiving, from the first computing device, time data that indicates an estimated time or period of time when the first guest might arrive at the first hotel.

6. The method of claim 1, further comprising:
causing, to be sent to the first guest, a message that notifies the first guest that the first hotel has assigned a particular room to the first guest.

7. The method of claim 1, wherein:
generating a scannable code that is associated with the first reservation data and that is to be presented to a clerk of the first hotel upon arrival of the first guest at the first hotel;
causing the scannable code to be sent to a second computing device of the first guest.

8. The method of claim 1, further comprising:
receiving, from the first computing device of the first guest, preference data that indicates one or more preferences of the first guest,
wherein the one or more preferences include one or more of a room type, a type of view, a noise level, a distance from an elevator, a distance from a vending machine, a floor level, a number of beds, a number of blankets, or a number of towels.

9. The method of claim 1, wherein the first reservation data includes two or more of a reservation number, a type of room that the first guest reserved, a date range for which the first guest reserved a room at the first hotel, payment information that is associated with the first guest, a price per night of a room at the first hotel, a total price for the date range, one or more attributes of the type of room, square footage of a particular hotel room, one or more photos of the particular hotel room, a view from a window of the particular hotel room, or a graphical confirm button.

10. The method of claim 1, further comprising:
causing, to be displayed on the first display screen of the first computing device, authorization data that indicates that if the first guest provides particular input that confirms the first reservation at the first hotel, then a financial account associated with the first guest will be charged;
after causing the authorization data to be displayed, receiving the particular input from the first computing device of the first guest.

11. The method of claim 1, wherein the one or more criteria includes the current date being the date on which the first guest is allowed to check-in at the first hotel.

12. The method of claim 1, further comprising:
causing, to be displayed on the first display screen of the first computing device of the first guest, hotel room data that allows the first guest to select a particular hotel room from among a plurality of hotel rooms of the hotel;
after receiving second input that indicates a selection of the particular hotel room, causing, to be displayed on the first display screen of the first computing device of the first user, room confirmation data that indicates that the first guest has selected the particular hotel room.

13. The method of claim 12, wherein the hotel room data includes data that indicates one or more of the plurality of hotel rooms as being unavailable.

14. The method of claim 12, wherein the hotel room data allows the first guest to select a floor from among a plurality of floors of the hotel.

15. The method of claim 14, further comprising:
receiving third input that indicates user selection of a particular floor of the plurality of floors;
in response to receiving the third input, causing, to be displayed on the first display screen of the first computing device, second hotel room data that indicates information about a second plurality of hotel rooms that reside on the particular floor of the hotel.

16. A method comprising:
receiving, from a computing device of a first guest, location data that indicates a first location of the computing device;
determining a second location of a hotel with which the first guest has made a reservation;
performing a comparison of the first location and the second location;
based on the comparison, causing, to be sent to a hotel computing device of the hotel, alert data that includes (a) distance data that indicates that the first guest is within a first distance of the hotel or (b) time data that indicates an estimate of when the first guest is to arrive at the hotel;
wherein the method is performed by one or more computing devices.

17. The method of claim 16, further comprising:
sending, to a second hotel computing device of the hotel, guest data that includes information about the first guest, wherein the information is one or more of a digital image of the first guest, demographic information of the first guest, or a hotel review that is attributed to the first guest, or a link to the digital image, the demographic information, or the hotel review.

18. The method of claim 16, further comprising:
storing geo-fence data that indicates a plurality of distances that includes the first distance and a second distance that is different than the first distance;
after causing the alert data to be sent to the hotel computing device:
receiving, from the computing device of the first guest, second location data that indicates a third location of the computing device;
performing a second comparison of the third location and the second location;
based on the second comparison, causing, to be sent to the hotel computing device of the hotel, second alert data that includes (a) second distance data that indicates that the first guest is within a second distance of the hotel or (b) second time data that indicates a second estimate of when the first guest is to arrive at the hotel.

19. The method of claim 16, wherein the hotel is a first hotel, the method further comprising:
receiving, from a second computing device of a second guest that is different than the first guest, second location data that indicates a third location of the second computing device;
determining a fourth location of a second hotel with which the second guest has made a second reservation, wherein the second hotel is owned by a different entity than the entity that owns the first hotel;
performing a second comparison of the third location and the fourth location;
based on the second comparison, causing, to be sent to a second hotel computing device of the second hotel, second alert data that includes (a) second distance data that indicates that the second guest is within a second distance of the second hotel or (b) second time data that indicates a second estimate of when the second guest is to arrive at the second hotel.

20. The method of claim 16, further comprising:
for each property of multiple properties:
storing guest data that indicates one or more guests that have reserved a room located at said each property;
arrival data that indicates an estimated time of when each of the one or more guests is to arrive at said each property;
upgrade data that indicates whether each guest of the one or more guests has accepted an upgrade offer.

21. The method of claim 18, wherein one of the multiple properties is owned by a first entity while another of the multiple properties is owned by a second entity that is different than the first entity.

22. One or more storage media carrying instructions which, when executed by one or more processors, further cause performance of the method recited in any one of claim 1.

23. One or more storage media carrying instructions which, when executed by one or more processors, further cause performance of the method recited in any one of claim 16.
